(19) United States
(12) Patent Application Publication
(10) Pub. No.: US 2019/0053662 A1
(43) Pub. Date: Feb. 21, 2019

(54) CLAMSHELL GRIDDLE

(71) Applicant: KCP FOOD (U.S.) INC., New York, NY (US)

(72) Inventors: Richard Ko, Lexington, MA (US); Wilson Suen, Ontario (CA)

(21) Appl. No.: 16/104,395

(22) Filed: Aug. 17, 2018

Related U.S. Application Data
(60) Provisional application No. 62/547,013, filed on Aug. 17, 2017.

(51) Int. Cl. A47J 37/06; A47J 36/02

(52) U.S. Cl. CPC A47J 37/0611; A47J 36/025

(57) ABSTRACT

Exemplary embodiments of a back panel and a clipping system for a clamshell griddle are provided. In some exemplary embodiments, a griddle apparatus is provided, including a base portion having a cooking surface thereon, a back wall substantially perpendicular to the base portion, an upper clamshell griddle that pivots with respect to the cooking surface between a first position substantially parallel to the cooking surface and a second position away from the cooking surface, and a removable back panel that is insertable between the upper clamshell griddle and the back wall, and configured to cover a portion of the back wall. A clipping system is also provided for securing a removable non-stick cooking surface to the upper clamshell griddle.

### CROSS-REFERENCE TO RELATED APPLICATIONS

This application relates to and claims priority from U.S. Provisional Patent Application Ser. No. 62/547,013 filed Aug. 17, 2017, the entire disclosure of which is hereby incorporated herein by reference.

### FIELD OF THE DISCLOSURE

The present disclosure relates to exemplary embodiments of a clamshell griddle, and more particularly, to a back panel and clipping system for a clamshell griddle.

### BACKGROUND INFORMATION

Two-sided cooking (e.g., cooking with heat applied from griddle plate members both above and below the food product) generally reduces the overall cooking time and the amount of operator attention required for cooking the food products. Not only is cooking time reduced with two-sided cooking, but certain foods can be improved in taste and texture by the application of force (e.g., a compressing of sandwiching type force) during the cooking process. Therefore, two-sided griddle-type cooking devices, also known as clamshell griddles, can be highly desirable in fast food restaurants.

However, the grease and residue resulting from using clamshell griddles can often be problematic and difficult to clean, particularly on the upper griddle. Further, it would be desirable to use a removable non-stick cooking surface on the clamshell griddle so that the upper griddle does not get dirty. It would be desirable to provide a griddle apparatus that is easy to clean which can provide for a removable non-stick cooking surface on the upper griddle.

### SUMMARY OF EXEMPLARY EMBODIMENTS OF THE DISCLOSURE

At least some of the above described problems can be addressed by exemplary embodiments of the present disclosure. Exemplary embodiments of the present disclosure can provide for a back panel and clipping system for a clamshell griddle.

In some exemplary embodiments, a griddle apparatus is provided, comprising a base portion having a cooking surface thereon, a back wall substantially perpendicular to the base portion, an upper clamshell griddle that pivots with respect to the cooking surface between a first position substantially parallel to the cooking surface and a second position away from the cooking surface, and a removable back panel that is insertable between the upper clamshell griddle and the back wall, and configured to cover a portion of the back wall.

The griddle apparatus can further comprise one or more curtains provided on a front surface of the back panel. The griddle apparatus can further comprise a lip provided on a top portion of the front surface of the back panel that is substantially perpendicular to the front surface, the lip configured to engage the back wall to support the back panel. The griddle apparatus can further comprise a handle on the lip that is substantially perpendicular to the lip. In some exemplary embodiments, the removable back panel can be substantially perpendicular to the cooking surface.

The griddle apparatus can further comprise one or more slots provided within each curtain. In some exemplary embodiments, each of the curtains can have a first end that terminates adjacent a top portion of the front surface, and a second end that extends to a bottom of the front surface to allow access within the slots of each curtain.

The griddle apparatus can further comprise a griddle pull bar connected to the upper clamshell griddle at a first end and to the back wall at a second end, the griddle pull bar configured to raise and lower the upper clamshell griddle, a weight configured to support the upper clamshell griddle in the second position, and a weight support bar connected to the weight at a first end and the back wall at a second end. In some exemplary embodiments, the griddle pull bar and weight support bar are configured to be provided within the slots of the back panel when the back panel covers the back wall. In some exemplary embodiments, the curtains can have a rectangular configuration.

In some exemplary embodiments, a griddle apparatus can be provided, comprising a base portion having a cooking surface thereon, an upper clamshell griddle that pivots with respect to the cooking surface between a first position substantially parallel to the cooking surface and a second position away from the cooking surface, the upper clamshell griddle having a lower surface configured to cook food, and a clipping system provided on the upper clamshell griddle configured to secure a removable non-stick cooking surface against the lower surface of the upper clamshell griddle. The clipping system can comprise one or more clips.

In some exemplary embodiments, the upper clamshell griddle can comprise a front surface, a first side surface and a second side surface, wherein each of the front surface, first side surface and second side surface are raised upwards from the lower surface of the upper clamshell griddle. In some exemplary embodiments, the one or more clips can be provided on an upper portion of the front surface, first side surface and second side surface to secure the removable non-stick cooking surface.

In some exemplary embodiments, each clip can comprise a first side portion on a first end and a second side portion on a second end that are biased together to engage the upper portion of the front surface, first side surface and second side surface. Each clip can further comprise a middle vertical portion having a top edge substantially perpendicular to the middle vertical portion configured to secure the clip against the upper portion of the front surface, first side surface and second side surface. In some exemplary embodiments, a bottom portion of each clip can flare outward. In some exemplary embodiments, a top portion of the first end and the second end have a circular configuration.

In some exemplary embodiments, the griddle apparatus can further comprise a back wall substantially perpendicular to the base portion, and a removable back panel that is insertable between the upper clamshell griddle and the back wall, and configured to cover a portion of the back wall, wherein the removable back panel is substantially perpendicular to the cooking surface. In some exemplary embodiments, the griddle apparatus can further comprise one or more curtains provided on a front surface of the back panel, and one or more slots provided within each curtain.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 illustrates a clamshell griddle according to an exemplary embodiment of the present disclosure;

FIG. 2 illustrates a clipping system being used in conjunction with an upper clamshell griddle according to an exemplary embodiment of the present disclosure;

FIG. 3 illustrates a back panel for a clamshell griddle according to an exemplary embodiment of the present disclosure; and

FIG. 4 illustrates a clip for a clipping system for a clamshell griddle according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

The exemplary embodiments of the present disclosure can provide for a back panel for a clamshell griddle that can prevent grease and dirt from covering the back portion of the clamshell griddle, and a clipping system to hold a nonstick cooking surface to the top surface of the clamshell griddle. Exemplary embodiments of the methods and systems will now be described with reference to the figures. The following description of the various embodiments is merely exemplary in nature and is in no way intended to limit the scope of the disclosure, its application, or uses.

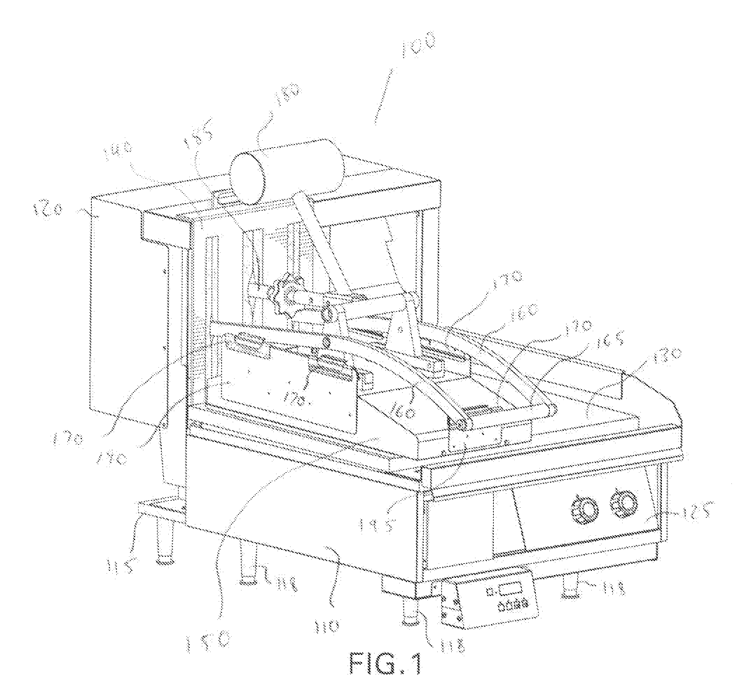

FIG. 1 illustrates a clamshell griddle according to an exemplary embodiment of the present disclosure. The clamshell griddle 100 can have a base 110 placed on a stand 115, can have a plurality legs 118. The clamshell griddle 100 also has a back portion or back wall 120 and a back panel 140, and can have various controls on a front panel 125. The clamshell griddle 100 can have a bottom cooking surface 130. An upper clamshell 150 is provided for pivoting and clamping down on food being cooked on the cooking surface 130. In some exemplary embodiments, two upper clamshells 150 can be provided on the cooking surface 130.

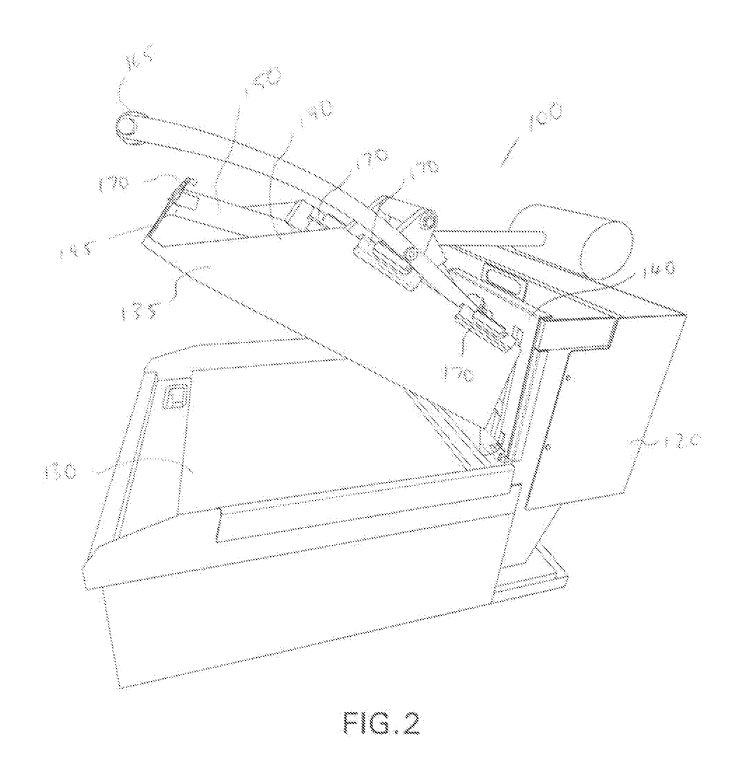

The upper clamshell 150 can have a griddle pull bar 165 to raise and lower the upper clamshell 150. The griddle pull bar 160 can have pull bar supports 160 that extend into the back panel 140. A weight 180 can be connected to a weight support bar 185 that extends into the back panel 140, as further described below. The weight 180 can help hold the upper clamshell 150 in a raised position when rested on the back wall 120, as shown in FIG. 2. Clips 170 can be provided to hold a nonstick cooking surface to the lower surface of the upper clamshell 150 that is placed on top of the food on the bottom cooking surface 130, as further described below.

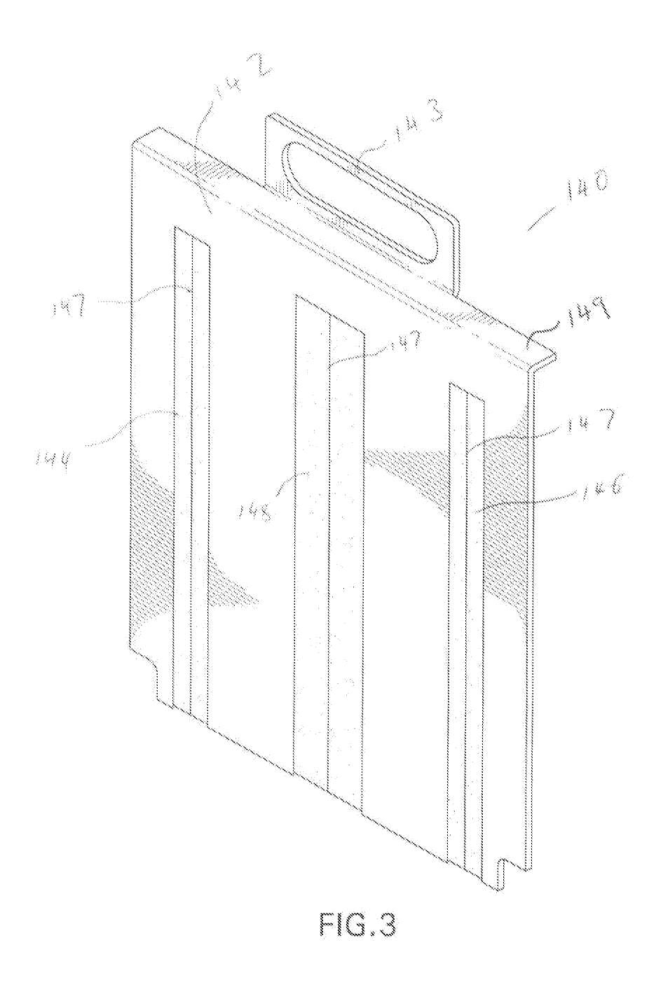

FIG. 3 illustrates a back panel for a clamshell griddle according to an exemplary embodiment of the present disclosure. As shown in FIG. 3, a back panel 140 for the clamshell griddle 100 is provided having a front surface 142. The front surface has curtains 144, 146 and 148, which can be but are not limited to a rectangular configuration. The front surface 142 can be but is not limited to a metal material, such as stainless steel, and the curtains 144, 146 and 148 can be but are not limited to a plastic or paper material. The curtains 144 and 146 provide a recess within slots 147 that open for the pull bar supports 160 to extend into and are supported by the back portion 120 within the curtains 144 and 146, as shown in FIG. 1. The curtain 148 provides a recess within slot 147 that open for the weight support bar 185 to extend into and are supported by the back portion 120 within the curtain 148, as shown in FIG. 1.

A lip 149 can be provided on a top portion of the back panel 140 that is perpendicular to the front surface 142 of the back panel 140. The lip 149 can engage with or sit on the back portion 120 of the clamshell griddle 100 to hold the back panel 140 on the back portion 120. In some exemplary embodiments, the lip 149 can be integral with the front surface 142. A handle 143 can be provided on the back panel 140 that allows a user to grasp the back panel 140 and slide the back panel 140 in and out for easy cleaning of the back panel 140. In some exemplary embodiments, the handle 143 can be formed on the lip 149 perpendicular to the lip 149, and can be integral with the lip 149 and the front surface 142. The curtains 144, 146 and 148 can have an upper first end that terminate at an upper portion of the front surface 142, and a bottom second end that are open so that the back panel 142 can slide out without interfering without interfering with the pull bar supports 160 and weight support bar 185. That is, the bottom portions of curtains 144 and 146 allow the pull bar supports 160 to slide within the curtains 144, 146, and the bottom portion of curtain 148 allow the weight support bar 185 to slide within the curtain 148. The back panel 140 can cover and keep the back portion 120 clean from grease, oils and residue that result from cooking.

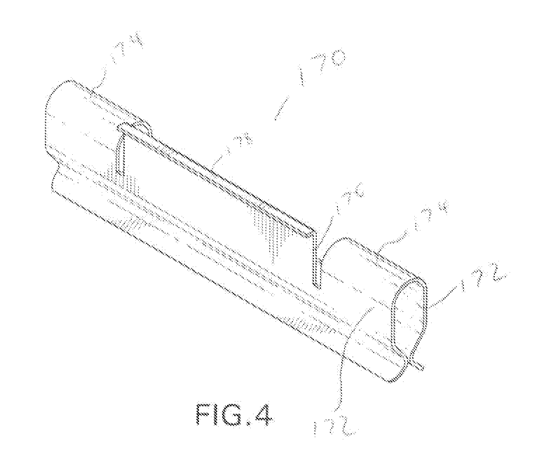

FIG. 4 illustrates a clip for a clipping system for a clamshell griddle according to an exemplary embodiment of the present disclosure. One or more clips 170 can be provided to secure a removable cooking surface on the lower surface of the upper clamshell 150, as shown in FIG. 2. The clip 170 can have two opposing side portions 172 on a first end and a second end that are biased together to be placed on a top portion of side surfaces 190 of the upper clamshell 150 and a front portion 195 of the upper clamshell 150, as further described below. That is, one or more clips can be placed at top portions of side surfaces 190, and a top portion of front portion 195. These top portions of side surfaces 190 and front portion 195 are placed within the two opposing side portions 172 of each clip 170. The clip 170 can have top opposing portions 174 of a circular or “loop” configuration above the side portion 172 on each end of the clip 170, and a middle vertical portion 176 between the two ends 172. The middle vertical portion 176 can have an edge 178 perpendicular to the middle vertical portion 176. The edge 178 can rest against a top portion of the front surface 195 and the first and second side surfaces 135, as shown in FIG. 2. The bottom portion of the clip 170 can flare out so that the top portions of the side surfaces 190 and the front portion 195 of the upper clamshell 150 can be easily placed within the clips 170.

FIG. 2 illustrates a clipping system being used in conjunction with an upper clamshell griddle 150 according to an exemplary embodiment of the present disclosure. As shown, a removable non-stick cooking surface 135 can be applied to a lower surface of the upper clamshell 150. The removable non-stick cooking surface 135 can be made of polytetrafluoroethylene (e.g., Teflon® or other similar material), and provided on the lower surface of the upper clamshell 150 so that food does not stick to the lower surface of the upper clamshell 150. In some exemplary embodiments, two clips 170 can be provided on each side surface 190 of the upper clamshell 150, and one clip 170 can be provided on the front portion 195 of the upper clamshell 150, as shown in FIG. 2. The clips 170 once inserted over the top portions of side surfaces 190 and front portion 195 and over the removable non-stick cooking surface 135 to hold the removable non-stick cooking surface 135 to the upper clamshell 150. The clips 170 are easily removed by lifting them to remove the removable non-stick cooking surface 135 when necessary to change or replace the removable non-stick cooking surface 135.

The clamshell griddle 100 can have various shapes and configurations, and are not limited to any shape or configuration. Various materials can be used for the construction of the clamshell griddle 100 and its components. Various different materials can be used to construct the non-stick cooking surface. Various components can be provided together, or individually.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A griddle apparatus, comprising:
a base portion having a cooking surface thereon;
a back wall substantially perpendicular to the base portion;
an upper clamshell griddle that pivots with respect to the cooking surface between a first position substantially parallel to the cooking surface and a second position away from the cooking surface; and
a removable back panel that is insertable between the upper clamshell griddle and the back wall, and configured to cover a portion of the back wall.

2. The griddle apparatus of claim 1, further comprising:
one or more curtains provided on a front surface of the back panel.

3. The griddle apparatus of claim 2, further comprising:
a lip provided on a top portion of the front surface of the back panel that is substantially perpendicular to the front surface, the lip configured to engage the back wall to support the back panel.

4. The griddle apparatus of claim 3, further comprising:
a handle on the lip that is substantially perpendicular to the lip.

5. The griddle apparatus of claim 2, wherein the removable back panel is substantially perpendicular to the cooking surface.

6. The griddle apparatus of claim 2, further comprising:
one or more slots provided within each curtain.

7. The griddle apparatus of claim 6, wherein each of the curtains have a first end that terminates adjacent a top portion of the front surface, and a second end that extends to a bottom of the front surface to allow access within the slots of each curtain.

8. The griddle apparatus of claim 7, further comprising:
a griddle pull bar connected to the upper clamshell griddle at a first end and to the back wall at a second end, the griddle pull bar configured to raise and lower the upper clamshell griddle;
a weight configured to support the upper clamshell griddle in the second position; and
a weight support bar connected to the weight at a first end and the back wall at a second end.

9. The griddle apparatus of claim 8, wherein the griddle pull bar and weight support bar are configured to be provided within the slots of the back panel when the back panel covers the back wall.

10. The griddle apparatus of claim 7, wherein the curtains have a rectangular configuration.

11. A griddle apparatus, comprising:
a base portion having a cooking surface thereon;
an upper clamshell griddle that pivots with respect to the cooking surface between a first position substantially parallel to the cooking surface and a second position away from the cooking surface, the upper clamshell griddle having a lower surface configured to cook food; and
a clipping system provided on the upper clamshell griddle configured to secure a removable non-stick cooking surface against the lower surface of the upper clamshell griddle.

12. The griddle apparatus of claim 11, wherein the clipping system comprises one or more clips.

13. The griddle apparatus of claim 12, wherein the upper clamshell griddle comprises a front surface, a first side surface and a second side surface, wherein each of the front surface, first side surface and second side surface are raised upwards from the lower surface of the upper clamshell griddle.

14. The griddle apparatus of claim 13, wherein one or more clips are provided on an upper portion of the front surface, first side surface and second side surface to secure the removable non-stick cooking surface.

15. The griddle apparatus of claim 14, wherein each clip comprises a first side portion on a first end and a second side portion on a second end that are biased together to engage the upper portion of the front surface, first side surface and second side surface.

16. The griddle apparatus of claim 15, wherein each clip further comprises a middle vertical portion having a top edge substantially perpendicular to the middle vertical portion configured to secure the clip against the upper portion of the front surface, first side surface and second side surface.

17. The griddle apparatus of claim 15, wherein a bottom portion of each clip flares outward.

18. The griddle apparatus of claim 15, wherein a top portion of the first end and the second end have a circular configuration.

19. The griddle apparatus of claim 15, further comprising:
a back wall substantially perpendicular to the base portion; and
a removable back panel that is insertable between the upper clamshell griddle and the back wall, and configured to cover a portion of the back wall, wherein the removable back panel is substantially perpendicular to the cooking surface.

20. The griddle apparatus of claim 19, further comprising:
one or more curtains provided on a front surface of the back panel; and
one or more slots provided within each curtain.
